(19) United States
(12) Patent Application Publication
(10) Pub. No.: US 2025/0137087 A1
(43) Pub. Date: May 1, 2025

(54) ULTRA-HIGH-STRENGTH STAINLESS STEEL AND MANUFACTURING METHOD

(71) Applicant: Beihang University, Beijing (CN)

(72) Inventors: Jinyan ZHONG, Beijing (CN); Songmei LI, Beijing (CN); Mei YU, Beijing (CN); Xiaoyu KUANG, Beijing (CN); Jianhua LIU, Beijing (CN); Xiaoliang ZHANG, Beijing (CN); Zhenjiang ZHAO, Beijing (CN); Yanbing MENG, Beijing (CN); Shuqi ZHANG, Beijing (CN); Jiahui CAI, Beijing (CN)

(21) Appl. No.: 18/777,801

(22) Filed: Jul. 19, 2024

(30) Foreign Application Priority Data
Oct. 27, 2023 (CN) 2023114074368

(51) Int. Cl. C21D 9/52; C21D 1/18; C21D 1/84; C21D 6/00; C21D 8/06; C22C 33/04; C22C 38/00; C22C 38/02; C22C 38/04; C22C 38/42; C22C 38/44; C22C 38/46; C22C 38/48; C22C 38/52; C22C 38/54

(52) U.S. Cl. CPC C21D 9/525; C21D 1/18; C21D 1/84; C21D 6/004; C21D 6/005; C21D 6/007; C21D 6/008; C21D 8/065; C22C 33/04; C22C 38/001; C22C 38/002; C22C 38/02; C22C 38/04; C22C 38/42; C22C 38/44; C22C 38/46; C22C 38/48; C22C 38/52; C22C 38/54

(57) ABSTRACT

Disclosed in the present disclosure are novel ultra-high-strength stainless steel and a manufacturing method. The novel ultra-high-strength stainless steel is composed of the following components in percentage by mass: C: 0.06-0.4%, Cr: 4-16%, Co: 8-17%, Ni: 2-15%, Mo: 1-7%, V: 0.1-0.8%, W: 0.2-3%, Nb: 0.01-0.3%, B: 0.1-0.3%, Si<0.1%, Mn<0.1%, Al<0.01%, Ti<0.015%, S<0.005%, P<0.008%, Cu<0.2%, La<0.2%, and the balance Fe and other inevitable impurities. The manufacturing process includes material melting, a high temperature diffusion process, cogging and forming of steel ingots, and material heat treatment. The novel ultra-high-strength stainless steel manufactured by using the method provided by the present disclosure has the tensile strength not lower than 2100 MPa, elongation not lower than 8%, reduction of area not lower than 40%, fracture toughness greater than 60 MPa \sqrt{m}, and a stress corrosion threshold greater than 40 MPa \sqrt{m}.

### TECHNICAL FIELD

The present disclosure belongs to the field of new materials, and in particular to novel ultra-high-strength stainless steel and a manufacturing method.

### BACKGROUND

At present, people pay more attention to stress corrosion resistance in the design of ultra-high strength steel. Since hypersonic aircrafts, unmanned aerial vehicles and other advanced aircrafts are more mobile and can fly under any conditions, important load-bearing parts of the aircrafts are required to have the functions of a light weight (weight reduction of over 5%), fatigue resistance, corrosion resistance, etc., and stainless steel (plating being omitted for parts so as to reduce the maintenance cost of the parts) having both ultra-high strength (σ_{b}≥2100 MPa) and corrosion resistance is urgently needed, so as to manufacture key load-bearing components having light weight, high reliability, long service life, such as a landing gear. Materials of 300M, AerMet100 and AerMet310 are sensitive to stress corrosion and hydrogen embrittlement. Parts made of these materials must be protected by electroplating, which is not conducive to environmental protection, increases the possibility of hydrogen embrittlement fracture of the parts and increases the maintenance cost of the parts. For the ultra-high strength stainless steel S53 developed abroad, the stainless steel S53 cannot satisfy the application requirements due to its low strength (σ_{b}=1930 MPa). In order to ensure the important load-bearing parts satisfy the requirement of the light weight (weight reduction of over 5%), the tensile strength (σ_{b}) of the material should not be less than 2100 MPa.

### SUMMARY

In order to solve the above problems, the present disclosure provides novel ultra-high-strength stainless steel and a manufacturing method. The tensile strength (δ_{b}) of the stainless steel is not lower than 2100 MPa, elongation (δ₅) is not lower than 8%, reduction of area (ψ) is not lower than 40%, fracture toughness (K_{IC}) is greater than 60 MPa \sqrt{m}, and a stress corrosion threshold (K_{ISCC}) is greater than 40 MPa \sqrt{m}.

The present disclosure employs the following technical solutions: Novel ultra-high-strength stainless steel is composed of the following components in percentage by mass: C: 0.06-0.4%, Cr: 4-16%, Co: 8-17%, Ni: 2-15%, Mo: 1-7%, V: 0.1-0.8%, W: 0.2-3%, Nb: 0.01-0.3%, B: 0.1-0.3%, Si<0.1%, Mn<0.1%, Al<0.01%, Ti<0.015%, S<0.005%, P<0.008%, Cu<0.2%, La<0.2%, and the balance Fe and other inevitable impurities.

Further, tensile strength of the stainless steel is not lower than 2100 MPa, elongation is not lower than 8%, reduction of area is not lower than 40%, fracture toughness is greater than 60 MPa \sqrt{m}, and a stress corrosion threshold is greater than 40 MPa \sqrt{m}.

A manufacturing method for the novel ultra-high-strength stainless steel mentioned above includes the following steps:
(1) performing quantitative weighing, weighing all raw materials according to material components: purity of pure metals in raw materials is not less than 99.5%, impurity elements satisfy that S≤0.001%, P≤0.002%, Mn≤0.1%, and Si≤0.1%;
(2) performing vacuum induction melting: performing melting in a vacuum induction furnace, where a melting temperature is 1490° C.-1530° C., the furnace is vacuumized, and a vacuum degree is ≤5 Pa;
(3) casting an electrode bar, demoulding a steel ingot, and performing slow cooling;
(4) performing rounding on the electrode bar: rounding the cooled electrode bar, where a rounding thickness is 15 mm-25 mm;
(5) performing remelting by using a consumable vacuum furnace: welding the electrode bar, where the furnace is vacuumized to the vacuum degree being ≤0.5 Pa; performing arcing with a current of 10,000 amperes-15,000 amperes; performing melting with a melting speed of 350 kg/h-440 kg/h, a current of 9,000 amperes-13,000 amperes, a voltage of 22 V-26 V; performing casting; demoulding the steel ingot, and performing slow cooling;
(6) rounding the steel ingot: rounding the cooled steel ingot, where a rounding thickness is 15 mm-25 mm;
(7) performing a high temperature diffusion process: performing preheating at 600° C., and performing heating to 800° C.-1000° C. with heat preservation time not less than 2 h; performing heating to 1180° C.-1250° C. with heat preservation time not less than 30 h;
(8) performing cogging and forging on the steel ingot:
(8-1) heating the steel ingot: heating the rounded steel ingot in natural gas or an oil furnace with a heating temperature of 1080° C.-1150° C., and performing heat preservation for 2 h after thorough burning;
(8-2) performing upsetting on the steel ingot: performing secondary upsetting on the steel ingot on a forging machine, where an upsetting temperature is 1080° C.-1150° C., a final forging temperature is ≥900° C., ash cooling is performed after forging, a forging ratio of the primary upsetting is 10-12, the forging ratio of the secondary upsetting is 13-15, and the steel ingot becomes a steel bar after upsetting;
(8-3) performing forging on the steel bar: forging the steel bar subjected to secondary upsetting on the forging machine, where the forging temperature is 1020° C.-1080° C., a final forging temperature is ≥900° C., ash cooling is performed after forging, the forged steel bar is annealed at 680° C.-700° C. for 8 h-16 h under air cooling; and
(9) performing material heat treatment: performing air cooling on the forged steel bar at 1080° C. for 1 h, performing preparatory heat treatment at 680° C.-700° C. for 8 h-16 h after air cooling, then roughly machining a sample, performing final heat treatment on the roughly machined sample, and then, performing sample finish machining to a required size.

Optionally, in step (8-3), the forging of the steel bar is divided into 2-3 times, namely the specific process of ϕ20 mm×500 mm: bar of ϕ160 mm→bar of ϕ100 mm→bar of ϕ50 mm→bar of ϕ20 mm×500 mm bar; or the specific process of ϕ20 mm×35 mm×450 mm: bar of ϕ160 mm→bar of ϕ100 mm→bar of ϕ20 mm×35 mm×450 mm.

Optionally, in step (9), the final heat treatment process is: performing heat preservation for 60 min-75 min at 1080° C.±10° C., and performing oil cooling; performing cold treatment within 8 h after quenching, where a temperature for the cold treatment is (−73° C.)+8° C., time for the heat preservation is not less than 2 h, and the temperature is returned to a room temperature in air; performing primary tempering heat treatment at 540° C.±3° C.-550° C.±3° C., where heat preservation is performed for 4 h, and air cooling is performed; then, performing cold treatment again, where a temperature for the cold treatment is (−73° C.)+8° C., time for heat preservation is not less than 2 h, and the temperature is returned to the room temperature in air; and performing secondary tempering heat treatment at 550° C.±3° C.-560° C.±3° C., where heat preservation is performed for 4 h, and air cooling is performed.

Compared with the prior art, the present disclosure has the following beneficial effects:

The novel ultra-high-strength stainless steel manufactured by using the method provided by the present disclosure has the tensile strength (σ_{b}) not lower than 2100 MPa and the fracture toughness (K_{IC}) greater than 60 MPa \sqrt{m}, and can be used for manufacturing important load-bearing parts with high strength and corrosion resistance requirements of advanced weapons and equipment.

### BRIEF DESCRIPTION OF THE DRAWINGS

To describe the technical solutions in the embodiments of the present disclosure or in the prior art more clearly, the accompanying drawings required in the embodiments will be briefly described below. The features and advantages of the present disclosure can be understood more clearly by referring to the accompanying drawings. The accompanying drawings are illustrative and shall not be construed as limiting the present disclosure in any way. Those of ordinary skill in the art can still derive other accompanying drawings from these accompanying drawings without creative efforts.

FIG. 1A shows lath martensite.

FIG. 1B shows dislocation.

FIG. 2A shows a high-resolution electron microscope photograph.

FIG. 2B shows diffraction calibration.

### DETAILED DESCRIPTION OF THE EMBODIMENTS

To make the above-mentioned objectives, features and advantages of the present disclosure be understood more clearly, the present disclosure will be described in detail below with reference to the accompanying drawings and particular embodiments. It needs to be noted that in the embodiments in the present disclosure and features in the embodiments can be combined with each other without conflict.

Many specific details are set forth in the following description to facilitate full understanding of the present disclosure, but the present disclosure may also be implemented in other ways different from those described herein, and therefore, the protection scope of the present disclosure is not limited by the particular embodiments disclosed below.

The present disclosure provides novel ultra-high-strength stainless steel, which is composed of C, Cr, Co, Ni, Mo, V, W, Nb, and B, and the balance Fe and other inevitable impurities. The specific component range of materials is shown in Table 1.

TABLE 1

| Element | Component range % |
|---|---|
| C | 0.06-0.4 |
| Cr | 4-16 |
| Co | 8-17 |
| Ni | 2-15 |
| Mo | 1-7 |
| V | 0.1-0.8 |
| W | 0.2-3 |
| Si | <0.1 |
| Mn | <0.1 |
| Al | <0.01 |
| Ti | <0.015 |
| S | <0.005 |
| P | <0.008 |
| Cu | <0.2 |
| La | <0.2 |
| Nb | 0.01-0.3 |
| B | 0.1-0.3 |
| Fe | Balance |

The present disclosure further provides a manufacturing method for the novel ultra-high-strength stainless steel mentioned above. The manufacturing method includes the following steps:

### 1.1 Determining Material Components.

1.2 Performing material melting

1.2.1 Manufacturing pure iron for steel making, where requirements on impurity elements of the pure iron for steel making are as follows: S≤0.001%, P≤0.002%, Mn≤0.1%, and Si<0.1%; and select pure metals required for melting, including Co, Cr, Mo, Ni, V, Nb, W, etc., where the purity is not less than 99.5%.

1.2.2 Performing vacuum induction melting: performing melting in a vacuum induction furnace, where a melting process and flow are as follows: a temperature for the melting is 1490° C.-1530° C., the furnace is vacuumized, and a vacuum degree is ≤5 Pa.

1.2.3 Casting an electrode bar, demoulding a steel ingot, and performing slow cooling.

1.2.4 Performing rounding on the electrode bar: rounding the cooled electrode bar, where a rounding thickness is 15 mm-25 mm.

1.2.5 Performing remelting by using a consumable vacuum furnace, where the consumable vacuum melting furnace is employed. The melting process is as follows: welding the electrode bar; vacuumizing the furnace to the vacuum degree being ≤0.5 Pa; performing arcing with a current of 10,000 amperes-15,000 amperes; performing melting with a melting speed of 350 kg/h-440 kg/h, a current of 9,000 amperes-13,000 amperes, a voltage of 22 V-26 V; performing casting; and demoulding the steel ingot, and performing slow cooling.

1.2.6 Rounding the steel ingot: rounding the cooled steel ingot, where a rounding thickness is 15 mm-25 mm.

1.3 Performing a high temperature diffusion process: performing preheating at 600° C., and performing heating to 800° C.-1000° C. with heat preservation time not less than 2 h; and performing heating to 1180° C.-1250° C. with heat preservation time not less than 30 h.

1.4 Performing cogging and forging on the steel ingot:

1.4.1 Heating the steel ingot: heating the rounded steel ingot in natural gas or an oil furnace with a heating temperature of 1080° C.-1150° C., and performing heat preservation for 2 h after thorough burning.

1.4.2 Performing upsetting on the steel ingot: performing secondary upsetting on the steel ingot on a forging machine, where an upsetting temperature is 1080° C.-1150° C., a final forging temperature is ≥900° C., slow cooling is performed after forging, a forging ratio of the primary upsetting is 10-12, the forging ratio of the secondary upsetting is 13-15, and the steel ingot becomes a steel bar after upsetting.

1.4.3 Performing forging on the steel bar: forging the steel bar subjected to secondary upsetting on the forging machine, where the forging temperature is 1020° C.-1080° C., a final forging temperature is ≥900° C., slow cooling is performed after forging, and the forged steel bar is annealed at 680° C.-700° C. for 8 h-16 h under air cooling.

1.5. Performing material heat treatment

Performing air cooling on the forged steel bar at 1080° C. for 1 h, performing preparatory heat treatment at 680° C.-700° C. for 8 h-16 h after air cooling, then roughly machining a sample, performing final heat treatment on the roughly machined sample, and then, performing sample finish machining to a required size. The final heat treatment process includes: performing heat preservation for 60 min-75 min at 1080° C.±10° C., and performing oil cooling; performing cold treatment within 8 h after quenching, where a temperature for the cold treatment is (−73° C.)+8° C., time for the heat preservation is not less than 2 h, and the temperature is returned to a room temperature in air; and performing primary tempering heat treatment at 540° C.±3° C.-550° C.±3° C., where heat preservation is performed for 4 h, and air cooling is performed. Then, performing cold treatment again, where a temperature for the cold treatment is (−73° C.)+8° C., time for heat preservation is not less than 2 h, and the temperature is returned to the room temperature in air; and perform secondary tempering heat treatment at 550° C.±3° C.-560° C.±3° C., where heat preservation is performed for 4 h, and air cooling is performed. Properties to be tested include a tensile property, fracture toughness and a stress corrosion property. The tensile strength (σ_{b}) is not lower than 2100 MPa, elongation (δ₅) is not lower than 8%, reduction of area (ψ) is not lower than 40%, the fracture toughness (K_{IC}) is greater than 60 MPa \sqrt{m}, and a stress corrosion threshold (K_{ISCC}) is greater than 40 MPa \sqrt{m}

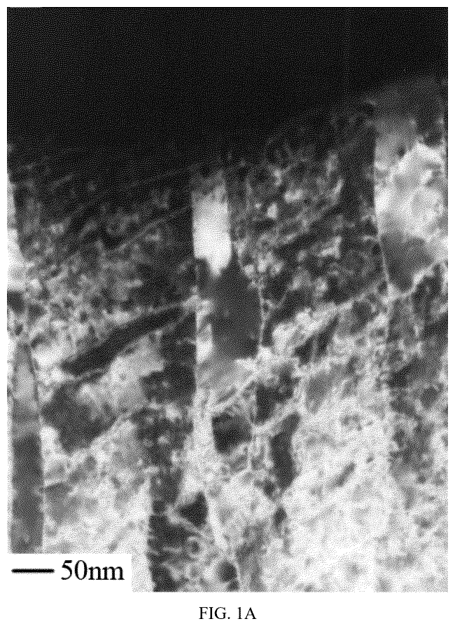

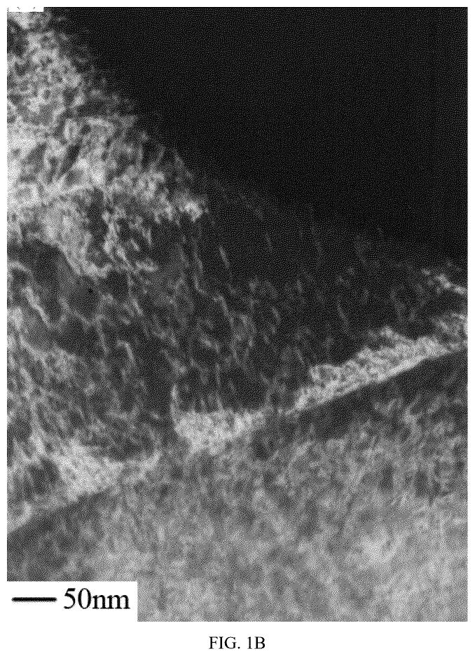

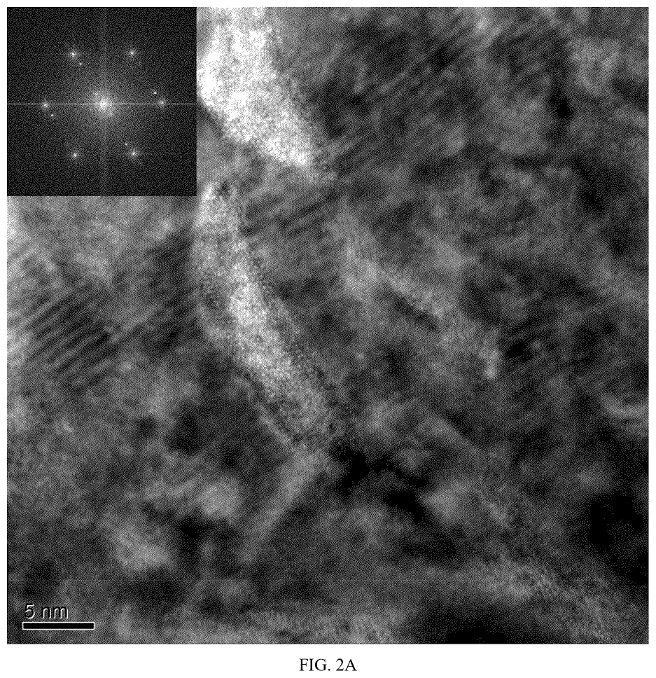

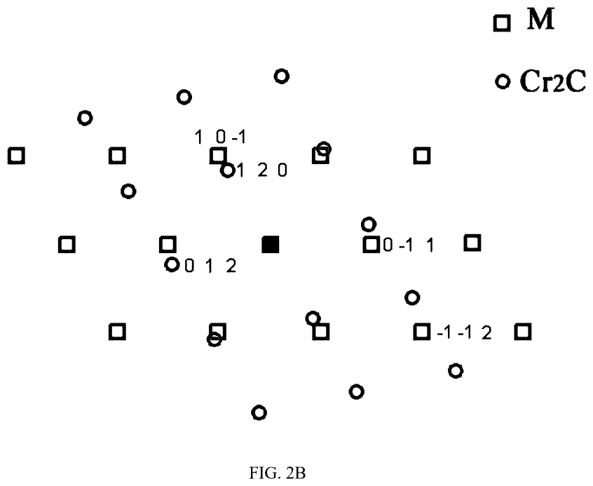

FIG. 1A, FIG. 1B, FIG. 2A and FIG. 2B show the microstructure of the novel ultra-high-strength stainless steel after heat treatment. As can be seen from FIG. 1A and FIG. 1B, the matrix structure of the steel is lath martensite with high density dislocation, and a width of the lath is about 20 nm to 60 nm, and a length is about 60 nm to 200 nm.

FIG. 2A shows that Cr₂C strengthening phases dispersed in the [−1 −1 2] direction are in the form of short rods, and the size is on the nanometer level. FIG. 2B is a computational simulation depicting this orientation relationship.

The strengthening phases of Cr₂C dispersed on the lath martensite matrix with high dislocation density can produce a quite strong precipitation strengthening effect, which makes stainless steel obtain ultra-high strength and high toughness.

The novel ultra-high-strength stainless steel and the manufacturing method provided by the present disclosure is described in detail below by way of particular embodiments.

### Embodiment 1

Material components and manufacturing steps are as follows:

1. Components: 0.16% of C, 12.12% of Cr, 4.69% of Mo, 12.62% of Co, 5.97% of Ni, 0.43% of V, 0.92% of W, 0.1% of Nb, 0.11% of B, Si<0.1%, Mn<0.1%, S<0.002%, P<0.005%, 0.0008% of N, and 0.0007% of O.

2. Pure iron for steel making is manufactured, where requirements on impurity elements of the pure iron for steel making are as follows: S≤0.001%, P≤0.002%, Mn≤0.1%, and Si≤0.1%; and pure metals required for melting are selected, including Co, Cr, Mo, Ni, etc., and the purity is not less than 99.5%.

3. Vacuum induction melting is performed: a 200 kg vacuum induction furnace made in China is employed for melting, and a melting process and flow are as follows: a temperature for the melting is 1530° C., the furnace is vacuumized, and a vacuum degree is 4 Pa.

4. An electrode bar of ϕ200 mm is cast, a steel ingot is demoulded, and slow cooling is performed.

5. The electrode bar is rounded: the cooled electrode bar is rounded to reach ϕ180 mm.

6. Remelting is performed by using a consumable vacuum furnace, where a consumable vacuum melting furnace of ISV11700 from western Germany is employed. The melting process is as follows: the electrode bar is welded, and the furnace is vacuumized to the vacuum degree being 0.5 Pa; arcing is performed with a current of 12,000 amperes; melting is performed with a melting speed of 400 kg/h, a current of 10,000 amperes, and a voltage of 25 V; then, casting is performed to obtain a steel ingot of ϕ180 mm; and the steel ingot is demoulded, and slow cooling are performed.

7. The steel ingot is rounded: the cooled steel ingot is rounded to reach ϕ160 mm.

8. A high temperature diffusion process is performed: preheating is performed at 600° C., and heat is performed to 900° C. with heat preservation time not less than 6 h. Heating is performed to 1200° C. with heat preservation time not less than 35 h.

9. Cogging and forging are performed on the steel ingot:

9.1. The steel ingot is heated: the rounded steel ingot is heated in natural gas or an oil furnace with a heating temperature of 1120° C., and heat preservation is performed for 2 h after thorough burning.

9.2. Upsetting is performed on the steel ingot: secondary upsetting is performed on the steel ingot on a forging machine, where an upsetting temperature is 1120° C., a final forging temperature is ≥900° C., and ash cooling is performed after forging. A forging ratio of the primary upsetting is 10.2, the forging ratio of the secondary upsetting is 13.2, and the steel ingot became a steel bar after upsetting.

9.3. The steel bar is forged into steel: the steel bar subjected to the secondary upsetting is forged, which is performed 2-3 times. The specific process of realizing the size of ϕ20 mm×500 mm is as follows: bar of ϕ160 mm→bar of ϕ100 mm→bar of ϕ50 mm→bar of ϕ20 mm×500 mm bar. Or the specific process of realizing the size of ϕ20 mm×35 mm×450 mm is as follows: bar of ϕ160 mm→bar of ϕ100 mm→bar of ϕ20 mm×35 mm×450 mm. The forging temperature is 1050° C., a final forging temperature is ≥900° C., and ash cooling is performed after forging. The forged steel bar is annealed at 680° C. for 8 h under air cooling.

10. Material heat treatment is performed

Air cooling is performed on the forged steel bar at 1080° C. for 1 h, and preparatory heat treatment is performed at 680° C. for 16 h after air cooling. Then, a sample is roughly machined, final heat treatment is performed on the roughly machined sample, and then, sample finish machining is performed to a required size. The final heat treatment process includes: heat preservation is performed for 60 min at 1080° C., and oil cooling is performed. Cold treatment is performed within 6 h after quenching, where a temperature for the cold treatment is (−73° C.), time for the heat preservation is 130 min, and the temperature is returned to a room temperature in air. Primary tempering heat treatment is performed at 540° C., where heat preservation is performed for 4 h, and air cooling is performed. Then, cold treatment is performed again, where a temperature for the cold treatment is (−71° C.), time for heat preservation is 130 min, and the temperature is returned to the room temperature in air. Secondary tempering heat treatment is performed at 550° C., where heat preservation is performed for 4 h, and air cooling is performed. Mechanical properties to be tested included a tensile property, fracture toughness and a stress corrosion property. The tensile strength (σ_{b}) is 2104 MPa, the elongation (δ₅) is 9.9%, the reduction of area (ψ) is 46.7%, the fracture toughness (K_{IC}) is greater than 61.33 MPa \sqrt{m}, and a stress corrosion threshold (K_{ISCC}) is 41.20 MPa \sqrt{m}.

### Embodiment 2

Material components and manufacturing steps are as follows:

1. Components: 0.163% of C, 12.08% of Cr, 4.68% of Mo, 12.66% of Co, 5.94% of Ni, 0.23% of V, 0.86% of W, 0.13% of Nb, 0.12% of B, Si<0.1%, Mn<0.1%, S<0.002%, P<0.005%, 0.0010% of N, and 0.0008% of O.

2. Pure iron for steel making is manufactured, where requirements on impurity elements of the pure iron for steel making are as follows: S≤0.001%, P≤0.002%, Mn≤0.1%, and Si≤0.1%; and pure metals required for melting are selected, including Co, Cr, Mo, Ni, etc., and the purity is not less than 99.5%.

3. Vacuum induction melting is performed: a 200 kg vacuum induction furnace made in China is employed for melting, and a melting process and flow are as follows: a temperature for the melting is 1530° C., the furnace is vacuumized, and a vacuum degree is 4 Pa.

4. An electrode bar of ϕ200 mm is cast, a steel ingot is demoulded, and slow cooling is performed.

5. The electrode bar is rounded: the cooled electrode bar is rounded to reach ϕ180 mm.

6. Remelting is performed by using a consumable vacuum furnace, where a consumable vacuum melting furnace of ISV11700 from western Germany is employed. The melting process is as follows: the electrode bar is welded, where the furnace is vacuumized to the vacuum degree being 0.5 Pa; arcing is performed with a current of 12,000 amperes; melting is performed with a melting speed of 400 kg/h, a current of 10,000 amperes, and a voltage of 25 V; then, casting is performed to obtain a steel ingot of ϕ180 mm; and the steel ingot is demoulded, and slow cooling are performed.

7. The steel ingot is rounded: the cooled steel ingot is rounded to reach ϕ160 mm.

8. A high temperature diffusion process is performed: preheating is performed at 600° C., and heat is performed to 930° C. with heat preservation time not less than 5 h. Heating is performed to 1220° C. with heat preservation time not less than 42 h.

9. Cogging and forging are performed on the steel ingot:

9.1. The steel ingot is heated: the rounded steel ingot is heated in natural gas or an oil furnace with a heating temperature of 1140° C., and heat preservation is performed for 2 h after thorough burning.

9.2. Upsetting is performed on the steel ingot: secondary upsetting is performed on the steel ingot on a forging machine, where an upsetting temperature is 1140° C., a final forging temperature is ≥900° C., and ash cooling is performed after forging. A forging ratio of the primary upsetting is 10.4, the forging ratio of the secondary upsetting is 13.5, and the steel ingot became a steel bar after upsetting.

9.3. The steel bar is forged into steel: the steel bar subjected to the secondary upsetting is forged, which is performed 2-3 times. The specific process of realizing the size of ϕ20 mm×500 mm is as follows: bar of ϕ160 mm→bar of ϕ100 mm→bar of ϕ50 mm→bar of ϕ20 mm×500 mm bar. Or the specific process of realizing the size of ϕ20 mm×35 mm×450 mm is as follows: bar of ϕ160 mm→bar of ϕ100 mm→bar of ϕ20 mm×35 mm×450 mm. The forging temperature is 1060° C., a final forging temperature is ≥900° C., and ash cooling is performed after forging. The forged steel bar is annealed at 680° C. for 10 h under air cooling.

10. Material heat treatment is performed

Air cooling is performed on the forged steel bar at 1080° C. for 1 h, and preparatory heat treatment is performed at 680° C. for 16 h after air cooling. Then, a sample is roughly machined, final heat treatment is performed on the roughly machined sample, and then, sample finish machining is performed to a required size. The final heat treatment process is: heat preservation is performed for 60 min at 1080° C., and oil cooling is performed. Cold treatment is performed within 5 h after quenching, where a temperature for the cold treatment is (−73° C.), time for the heat preservation is 135 min, and the temperature is returned to a room temperature in air. Primary tempering heat treatment is performed at 545° C., where heat preservation is performed for 4 h, and air cooling is performed. Then, cold treatment is performed again, where a temperature for the cold treatment is (−72° C.), time for heat preservation is 135 min, and the temperature is returned to the room temperature in air. Secondary tempering heat treatment is performed at 550° C., where heat preservation is performed for 4 h, and air cooling is performed. Properties to be tested included a tensile property, fracture toughness and a stress corrosion property. The tensile strength (σ_{b}) is 2102 MPa, the elongation (δ₅) is 9.7%, the reduction of area (ψ) is 43.4%, the fracture toughness (K_{IC}) is greater than 60.55 MPa \sqrt{m}, and a stress corrosion threshold (K_{ISCC}) is 40.60 MPa \sqrt{m}Embodiment 3:

Material components and manufacturing steps are as follows:

1. Components: 0.167% of C, 12.11% of Cr, 4.64% of Mo, 12.75% of Co, 6.02% of Ni, 0.36% of V, 0.90% of W, 0.11% of Nb, 0.14% of B, Si<0.1%, Mn<0.1%, S<0.002%, P<0.005%, 0.0009% of N, and 0.0010% of O.

2. Pure iron for steel making is manufactured, where requirements on impurity elements of the pure iron for steel making are as follows: S≤0.001%, P≤0.002%, Mn≤0.1%, and Si≤0.1%; and pure metals required for melting are selected, including Co, Cr, Mo, Ni, etc., and the purity is not less than 99.5%.

3. Vacuum induction melting is performed: a 200 kg vacuum induction furnace made in China is employed for melting, and a melting process and flow are as follows: a temperature for the melting is 1540° C., the furnace is vacuumized, and a vacuum degree is 4 Pa.

4. An electrode bar of ϕ200 mm is cast, a steel ingot is demoulded, and slow cooling is performed.

5. The electrode bar is rounded: the cooled electrode bar is rounded to reach ϕ180 mm.

6. Remelting is performed by using a consumable vacuum furnace, where a consumable vacuum melting furnace of ISV11700 from western Germany is employed. The melting process is as follows: the electrode bar is welded, where the furnace is vacuumized to the vacuum degree being 0.5 Pa; arcing is performed with a current of 12,000 amperes; melting is performed with a melting speed of 400 kg/h, a current of 10,000 amperes, and a voltage of 25 V; then, casting is performed to obtain a steel ingot of ϕ180 mm; and the steel ingot is demoulded, and slow cooling are performed.

7. The steel ingot is rounded: the cooled steel ingot is rounded to reach ϕ160 mm.

8. A high temperature diffusion process is performed: preheating is performed at 600° C., and heat is performed to 960° C. with heat preservation time not less than 5 h. Heating is performed to 1230° C. with heat preservation time not less than 44 h.

9. Cogging and forging are performed on the steel ingot:

9.1. The steel ingot is heated: the rounded steel ingot is heated in natural gas or an oil furnace with a heating temperature of 1150° C., and heat preservation is performed for 2 h after thorough burning.

9.2. Upsetting is performed on the steel ingot: secondary upsetting is performed on the steel ingot on a forging machine, where an upsetting temperature is 1150° C., a final forging temperature is ≥900° C., and ash cooling is performed after forging. A forging ratio of the primary upsetting is 10.3, the forging ratio of the secondary upsetting is 13.4, and the steel ingot became a steel bar after upsetting.

9.3. The steel bar is forged into steel: the steel bar subjected to the secondary upsetting is forged, which is performed 2-3 times. The specific process of realizing the size of ϕ20 mm×500 mm is as follows: bar of ϕ160 mm→bar of ϕ100 mm→bar of ϕ50 mm→bar of ϕ20 mm×500 mm bar. Or the specific process of realizing the size of ϕ20 mm×35 mm×450 mm is as follows: bar of −160 mm→bar of ϕ100 mm→bar of ϕ20 mm×35 mm×450 mm. The forging temperature is 1070° C., a final forging temperature is ≥900° C., and ash cooling is performed after forging. The forged steel bar is annealed at 680° C. for 16 h under air cooling.

10. Material heat treatment is performed

Air cooling is performed on the forged steel bar at 1080° C. for 1 h, and preparatory heat treatment is performed at 680° C. for 16 h after air cooling. Then, a sample is roughly machined, final heat treatment is performed on the roughly machined sample, and then, sample finish machining is performed to a required size. The final heat treatment process was: heat preservation is performed for 60 min at 1080° C., and oil cooling is performed. Cold treatment is performed within 6 h after quenching, where a temperature for the cold treatment is (−73° C.), time for the heat preservation is 130 min, and the temperature is returned to a room temperature in air. Primary tempering heat treatment is performed at 550° C., where heat preservation is performed for 4 h, and air cooling is performed. Then, cold treatment is performed again, where a temperature for the cold treatment is (−72° C.), time for heat preservation is 130 min, and the temperature is returned to the room temperature in air. Secondary tempering heat treatment is performed at 555° C., where heat preservation is performed for 4 h, and air cooling is performed. Properties to be tested included a tensile property, fracture toughness and a stress corrosion property. The tensile strength (σ_{b}) is 2101 MPa, the elongation (δ₅) is 11.7%, the reduction of area (ψ) is 52.1%, the fracture toughness (K_{IC}) is greater than 60.92 MPa \sqrt{m}, and a stress corrosion threshold (K_{ISCC}) is 40.90 MPa \sqrt{m}.

In the present disclosure, it should be noted that, unless otherwise explicitly specified and defined, the terms “mounting”, “connecting”, “connection”, “fixing”, etc. should be understood in a broad sense, and may denote, for example, fixed connection, detachable connection, integrated connection, mechanical connection, electrical connection, direct connection, indirect connection via an intermediate medium, communication between interior of two elements or interaction between two elements. The specific meanings of the above terms in the present disclosure may be understood on a case-by-case basis for those of ordinary skill in the art.

In the present disclosure, unless otherwise explicitly specified and defined, a first feature being “above” or “below” a second feature may include the first feature and the second feature being in direct contact, or may include the first feature and the second feature not being in direct contact but being in contact via another feature therebetween. Furthermore, the first feature being “above”, “over” and “on” the second feature includes the first feature being over and obliquely above the second feature, or simply indicates that the first feature is higher in horizontal elevation than the second feature. The first feature being “below”, “under” and “underneath” the second feature includes the first feature is under and obliquely below the second feature, or simply indicates that the first feature is lower in horizontal elevation than the second feature.

In the disclosure, the terms “first”, “second”, “third” and “fourth” are merely for descriptive purposes only and should not be construed as indicating or implying relative importance. The term “plurality” means two or more, unless expressly specified otherwise.

The above has been described only as preferred embodiments of the present disclosure and is not intended to limit the present disclosure, which can be modified and changed, for those skilled in the art. Any modifications, equivalent substitutions, improvements, etc. within the spirit and principles of the present disclosure are intended to fall within the scope of protection of the present disclosure.

What is claimed is:

1. Novel ultra-high-strength stainless steel, being composed of the following components in percentage by mass: C: 0.06-0.4%, Cr: 4-16%, Co: 8-17%, Ni: 2-15%, Mo: 1-7%, V: 0.1-0.8%, W: 0.2-3%, Nb: 0.01-0.3%, B: 0.1-0.3%, Si<0.1%, Mn≤0.1%, Al<0.01%, Ti<0.015%, S≤0.005%, P≤0.008%, Cu<0.2%, La<0.2%, and the balance Fe and other inevitable impurities.

2. The novel ultra-high-strength stainless steel according to claim 1, wherein tensile strength of the stainless steel is not lower than 2100 MPa, elongation is not lower than 8%, reduction of area is not lower than 40%, fracture toughness is greater than 60 MPa \sqrt{m}, and a stress corrosion threshold is greater than 40 MPa \sqrt{m}.

3. A manufacturing method for the novel ultra-high-strength stainless steel according to claim 1, comprising the following steps:
(1) performing quantitative weighing, weighing all raw materials according to material components: purity of pure metals in raw materials is not less than 99.5%, impurity elements satisfy that S≤0.001%, P≤0.002%, Mn≤0.1%, and Si<0.1%;
(2) performing vacuum induction melting: performing melting in a vacuum induction furnace, wherein a melting temperature is 1490° C.-1530° C., the furnace is vacuumized, and a vacuum degree is ≤5 Pa;
(3) casting an electrode bar, demoulding a steel ingot, and performing slow cooling;
(4) performing rounding on the electrode bar: rounding the cooled electrode bar, wherein a rounding thickness is 15 mm-25 mm;
(5) performing remelting by using a consumable vacuum furnace: welding the electrode bar, wherein the furnace is vacuumized to the vacuum degree being ≤0.5 Pa; performing arcing with a current of 10,000 amperes-15,000 amperes; performing melting with a melting speed of 350 kg/h-440 kg/h, a current of 9,000 amperes-13,000 amperes, a voltage of 22 V-26 V; performing casting; demoulding the steel ingot, and performing slow cooling;
(6) rounding the steel ingot: rounding the cooled steel ingot, wherein a rounding thickness is 15 mm-25 mm;
(7) performing a high temperature diffusion process: performing preheating at 600° C., and performing heating to 800° C.-1000° C. with heat preservation time not less than 2 h; performing heating to 1180° C.-1250° C. with heat preservation time not less than 30 h;
(8) performing cogging and forging on the steel ingot:
(8-1) heating the steel ingot: heating the rounded steel ingot in natural gas or an oil furnace with a heating temperature of 1080° C.-1150° C., and performing heat preservation for 2 h after thorough burning;
(8-2) performing upsetting on the steel ingot: performing secondary upsetting on the steel ingot on a forging machine, wherein an upsetting temperature is 1080° C.-1150° C., a final forging temperature is ≥900° C., ash cooling is performed after forging, a forging ratio of the primary upsetting is 10-12, the forging ratio of the secondary upsetting is 13-15, and the steel ingot becomes a steel bar after upsetting;
(8-3) performing forging on the steel bar: forging the steel bar subjected to secondary upsetting on the forging machine, wherein the forging temperature is 1020° C.-1080° C., a final forging temperature is ≥900° C., ash cooling is performed after forging, the forged steel bar is annealed at 680° C.-700° C. for 8 h-16 h under air cooling; and
(9) performing material heat treatment: performing air cooling on the forged steel bar at 1080° C. for 1 h, performing preparatory heat treatment at 680° C.-700° C. for 8 h-16 h after air cooling, then roughly machining a sample, performing final heat treatment on the roughly machined sample, and then, performing sample finish machining to a required size.

4. The method according to claim 3, wherein in step (8-3), the forging of the steel bar is divided into 2-3 times, namely the specific process of ϕ20 mm×500 mm: bar of ϕ160 mm→bar of ϕ100 mm→bar of ϕ50 mm→bar of ϕ20 mm×500 mm bar; or the specific process of ϕ20 mm×35 mm×450 mm: bar of ϕ160 mm→bar of ϕ100 mm→bar of ϕ20 mm×35 mm×450 mm.

5. The method according to claim 3, wherein in step (9), the final heat treatment process is: performing heat preservation for 60 min-75 min at 1080° C.±10° C., and performing oil cooling; performing cold treatment within 8 h after quenching, wherein a temperature for the cold treatment is (−73° C.)+8° C., time for the heat preservation is not less than 2 h, and the temperature is returned to a room temperature in air; performing primary tempering heat treatment at 540° C.±3° C.-550° C.±3° C., wherein heat preservation is performed for 4 h, and air cooling is performed; then, performing cold treatment again, wherein a temperature for the cold treatment is (−73° C.)+8° C., time for heat preservation is not less than 2 h, and the temperature is returned to the room temperature in air; and performing secondary tempering heat treatment at 550° C.±3° C.-560° C.±3° C., wherein heat preservation is performed for 4 h, and air cooling is performed.
